(19) United States
(12) Patent Application Publication
(10) Pub. No.: US 2011/0072047 A1
(43) Pub. Date: Mar. 24, 2011

(54) Interest Learning from an Image Collection for Advertising

(75) Inventors: Xin-Jing Wang, Beijing (CN); Lei Zhang, Beijing (CN); Wei-Ying Ma, Beijing (CN)

(73) Assignee: Microsoft Corporation, Redmond, WA (US)

(21) Appl. No.: 12/563,955

(22) Filed: Sep. 21, 2009

(51) Int. Cl. G06F 17/30

(52) U.S. Cl. 707/776; 707/E17.071

(57) ABSTRACT

Described herein is a technology that facilitates learning interests for advertising based on automated analysis of images. In several embodiments a person's interests are automatically learned based on the person's photographs for targeted advertising. Techniques are described that facilitate automatically detecting a user's interest from images and suggesting user-targeted ads. As described herein, these techniques include computer-annotating images with learned tags, performing topic learning to obtain an interest model, and performing advertisement matching and ranking based on the interest model.

### BACKGROUND

As digital cameras and digital camera enabled cellular telephones have become increasingly popular with consumers, photographs taken by the consumers are being shared in a variety of ways including via web pages and web sites. In the meantime, web site operators and advertisers continue to seek effective ways to market their wares and reach potential customers.

Although digital photographs have become a prolific mode of human communication, developing an understanding of a person's interests based on image topic learning has not been tapped as a source for targeting advertising.

Typically some, but not all users tag their photos with personally relevant tags. One use for these tags is to determine which images should be returned when users conduct image searches based on textual queries. Additionally, currently when advertising is provided the advertising is selected by matching advertising keywords to the terms of textual queries entered by users conducting searches.

However, these conventional techniques do not automatically ascertain a person's interests based on the person's photographs in order to provide targeted advertising.

### SUMMARY

A technology that facilitates automated learning of a person's interests based on the person's photographs for advertising is described herein. Techniques are described that facilitate automated detecting of a user's interest from shared images and suggesting user-targeted ads. As described herein, these techniques include computer-annotating images with learned tags, performing topic learning to obtain an interest model, and performing advertisement matching and ranking based on the interest model.

This Summary is provided to introduce a selection of concepts in a simplified form that are further described below in the Detailed Description. This Summary is not intended to identify key or essential features of the claimed subject matter, nor is it intended to be used to limit the scope of the claimed subject matter.

### BRIEF DESCRIPTION OF THE DRAWINGS

FIG. 1 is a system diagram showing illustrative logical relationships for implementing interest learning from images for advertising.

FIG. 2 is a flow diagram showing an illustrative process of providing relevant advertising from learning user interest based on one or more images.

FIG. 3 is a flow diagram showing an illustrative process of providing relevant advertising from learning interest based on one or more images.

FIG. 4 is a flow diagram showing additional aspects of an illustrative process of implementing interest learning from an image collection for advertising.

FIG. 5 is a flow diagram showing additional aspects of an illustrative process of implementing interest learning from an image collection for advertising.

FIG. 6 is a flow diagram showing additional aspects of an illustrative process of implementing interest learning from an image collection for advertising.

FIG. 7 is a flow diagram showing additional aspects of an illustrative process of implementing interest learning from an image collection for advertising.

FIG. 8 is a graph illustrating average precision of three models for identifying relevant advertisements in an illustrative process of implementing interest learning from an image collection for advertising.

FIG. 9 illustrates an example of a topic bridging model (TB) as performed in at least one embodiment of interest learning from an image collection for advertising.

FIG. 10 is a data chart showing an illustrative implementation of interest learning from a personal image collection for advertising.

FIG. 11 illustrates an illustrative operating environment.

The detailed description is set forth with reference to the accompanying figures. In the figures, the left-most digit of a reference number identifies the figure in which the reference number first appears. The use of the same reference numbers in different figures indicates similar or identical items. A reference number having a parenthetical suffix (as in “104(1)” or “112(a)”) identifies a species of the feature represented by the general reference number (e.g., “104” or “112”); further, use of the general reference number without a parenthetical suffix (as in “104” or “112”) identifies the genus or any one or more of the species.

### DETAILED DESCRIPTION

### Overview

This disclosure is directed to techniques for interest learning from a personal photo collection for advertising. The described operations facilitate targeted advertising based on images.

The described techniques, systems, and tools facilitate intelligent advertising by targeting advertisements based on interests expressed in user images including user generated or collected content such as via personal photo collections, personal web pages, and/or photo sharing streams such as Flickr™, Picasa™, and Shutterfly™, and/or photo forums such as Photo.Net, PhotoSig, Trekearch, Usefilm, DPChallenge. A system in which these and other techniques may be enabled is set forth first below. Additional sections describe various inventive techniques and exemplary embodiments. These sections describe exemplary ways in which the inventive tools enable interest learning from a personal image collection for advertising such that targeted advertisements are delivered based on the image collection. An environment in which these and other techniques may be enabled is also set forth.

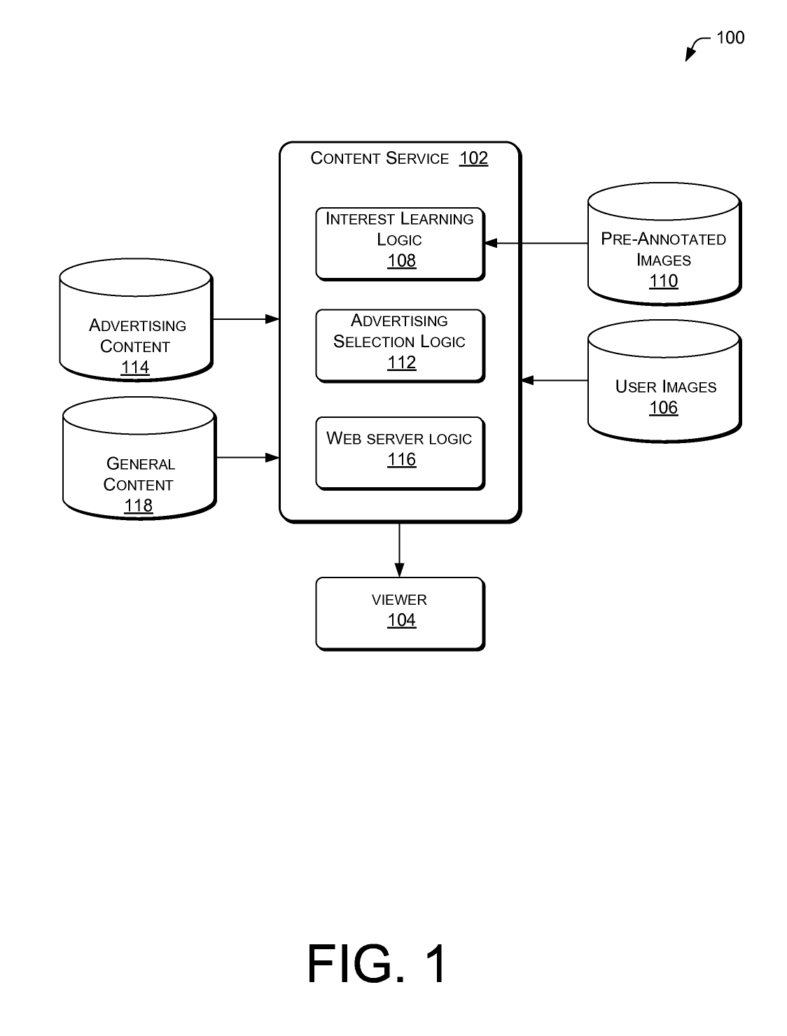

FIG. 1 shows a system 100 that serves content and advertising to a user. The advertising is chosen dynamically so that it corresponds to interests of the user.

System 100 includes a content service 102 that provides content to a user through a viewer 104. Content service 102 might be a network-based service such as an Internet site, also referred to as a website. A website such as this potentially comprises a number of components such as one or more physical and logical servers. In addition, the website and its servers might have access to other resources of the Internet and World-Wide-Web, such as various content and databases.

Viewer 104 might be an Internet browser that operates on a personal computer or other device having access to a network such as the Internet. Various browsers are available, such as Microsoft Corporation's Internet Explorer. Internet or web content might also be viewed using other viewer technologies such as viewers used in various types of mobile devices, or using viewer components in different types of application programs and software-implemented devices.

In the described embodiment the various devices, servers, and resources operate in a networked environment in which they can communicate with each other. For example, the different components are connected for intercommunication using the Internet. However, various other private and public networks might be utilized for data communications between entities of system 100.

Content service 102 has web server logic 116 that responds to requests from viewer 104 by providing appropriate content. Microsoft's IIS (Internet Information Services) is an example of widely used software that might be used in this example to implement web server logic 116.

In response to requests, web server logic 116 retrieves and provides various types of content, including general content 118, user images 106, and advertising content 114. Depending on the nature of the website implemented by content service 102, the content might comprise various different media types, including text, graphics, pictures, video, audio, etc. The exact nature of the content is of course determined by the objectives of the website.

A picture sharing website is one example of a website with which the technology described below might be used. The Internet has many different examples of picture sharing websites, such as Flickr™, Shutterfly™, PictureShare™, PictureTrail™, photo-blogs, etc. Users can store their own pictures on the websites, and can later view those pictures. Access can also be granted to other users to view the pictures, and the user can often perform searches for other users' pictures or browse categorized selections of pictures.

In this context, user images 106 might comprise pictures supplied by a user of content service 102. General content 118 might comprise other available pictures and other types of content that are provided to viewer 104. For example, a website might have various other features in addition to picture sharing, such as discussion, chat, and news features.

Many content providers and websites use advertising to produce revenue. Such advertising is presented alongside the primary content of the website. In a picture sharing website, for example, graphical advertisements might be displayed in a column on one side of the pictures, interspersed with the pictures, or superimposed on the picture. Many different types of advertising can be rendered on viewer 104, including text based advertising, graphical advertisements, and even audio/video advertisements.

The advertisements themselves are often retrieved from one or more third-party sources. FIG. 1 shows advertising content 114 as an example of such sources. When serving content to viewer 104, content service 102 retrieves one or more advertisements from advertising content 114 and serves those with the primary content requested by the user.

Although advertisements can be selected randomly, so-called “targeted” advertising can produce higher revenue. Targeted advertising selects advertisements based on the identified interests of the user who has requested content. User interests can be identified in many different ways, but one of the most common is to base the identification on the type of web content the user has requested. If the user has requested or is viewing information relating to a city, for example, the website might serve advertisements for businesses located in that city.

With text-based content, it is relatively easy to determine user interests based on textual or semantic analysis. When the content is pictures, however, it is much more difficult to identify user interests.

In some situations, pictures have associated tags. Such tags are entered by users and can help in identifying the subject matter of a picture. However, users sometimes tag images or photographs with names or captions, like tagging a photo of a dog with the dog's name. Even when users save or submit tags with their photographs the user-submitted tags may not be particularly relevant to understanding the user's interest associated with the image. Nor will the user-submitted tags necessarily be helpful for targeting advertising because, for example, a dog's name is personal and not likely to be associated with an advertisement. Furthermore, user-submitted tags may cause a lexical gap as may be understood from the following example. Users often tag photos with names, like tagging a picture of a dog with the dog's name. However, the dog's name is not likely to be in the text associated with an advertisement. Thus a lexical, or word gap would exist for targeting advertising based on the user-submitted tags. Similarly, a semantic gap, although more complex, may be understood from the following example. The term “car” may appear in user-submitted tags, but semantically that is not enough to know whether the user might be interested in seeing advertisements for cars, car accessories, car insurance, etc. Having the brand of car in a user-submitted tag may be helpful to show relevant advertisements for accessories, but an advertisement for car insurance may be at least as relevant for targeted advertising.

Furthermore, many pictures do not have associated tags, and thus tag-based interest analysis is often impossible.

System 100 has interest learning logic 108 that determines user interest based on a user's collection of pictures, even when those pictures do not have tags or other descriptive text. Interest learning logic 108 represents functionality for mining interest. Although the described embodiment discusses user interest, the techniques described herein are also useful to determine consumer interest, such as by demographic, group interest, such as by affiliation, entity interest such as by business entity, etc.

The user's image collection, which learning logic 108 uses to determine user interest, can be a single picture or a plurality of pictures. Generally, the more images the user has relating to a topic, the more interesting or important that topic is likely to be to the user. In addition, using more than one picture often helps disambiguate between different possible topics. A single photo, for instance, might show a pet in front of a car. Using that particular photo, it might be difficult to determine whether the user is interested in pets or cars. Given a larger number of photos, however, it is likely that many of the photos will show the dog but not the car. This makes it easier to conclude that the pet is the real topic of interest.

Fortunately, user images 106 is often stored in folders or segregated by subject matter in some way, so that images relating to a single topic are often identifiable. For example, pictures of a pet may be stored in their own folder and/or displayed on their own web page.

User images may come from multiple sources. For example, the images may be personal photos taken by the user with a digital camera as discussed above. Images may also include images from other sources including scanned images, images downloaded or obtained from the internet, images obtained from other users, etc. A collection of user images might even be defined by the results of some sort of Internet search.

In at least one embodiment, user images 106 embodies a personal image collection stored on a personal web page and/or photo sharing site such as Flickr™, Shutterfly™, PictureShare™, PictureTrail™, photo-blogs, etc. Alternatively, such user images might be on a user's local computer and used in conjunction with a locally-executable application program such as Picasa™, MyPhotoIndex, etc. Furthermore, locally stored content might be used in conjunction with web-based applications, or remotely stored content might be used in conjunction with application programs executing on a local computer. Personal image collections can generally be described as a collection of images having particular meaning to a user or in some instances a group of users.

Personal image collections may be stored as user images 106 on a computing device and/or on network storage. In some instances personal image collections are stored in folders or shared in streams with designations that are meaningful to the user. Because users share their personal image collections, the shared personal image collections are accessible for mining In addition, users may collect images by browsing internet web pages. Collections of these browsed images may be mined even if the user does not explicitly save the images. In the instance of browsed images, user images 106 may contain the browsed images in a separate folder and/or the browsed images may augment images of the various collections. This may be useful for weighting as discussed below regarding block-wise topic identification.

In order to determine user interest based on user pictures that are not tagged, interest learning logic 108 references pre-annotated images 110. Pre-annotated images 110, (also referred to as image corpus or image repository) may be any or a combination of several collections of digitized images. For example, several universities maintain image databases for image recognition, processing, computer vision, and analysis research. In addition image databases including stock photographs, illustrations, and other images are available commercially from vendors like Corbis Corporation. In some instances such databases are cataloged or divided into volumes based on content, features, or a character of the imaged. In other instances, the individual images are tagged or associated with descriptive text.

Furthermore, pre-annotated images 110 might comprise general collections of user-tagged pictures, such as the large collections of images available on popular web services. The Internet provides a vast resource of images, and semantic information can be learned from many of these images based on surrounding textual information.

In addition to the components described so far, system 100 has advertising selection logic 112 that selects advertising from advertising content 114 based on the determination of learning logic 108 of the user's interests. Generally, this is accomplished by searching for advertisements having topics corresponding to the user's interests, based on keyword searching or other techniques as described more fully below. In at least one embodiment advertisements may be solicited based on topics corresponding to the user's interests.

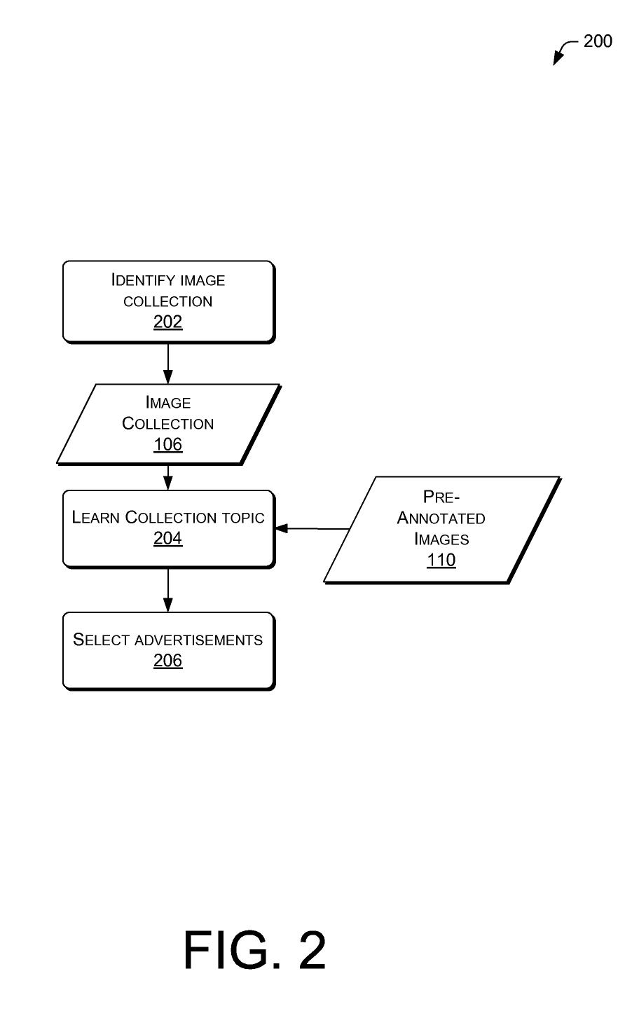

FIG. 2 shows an illustrative process 200 as performed by system 100 of FIG. 1 for providing relevant advertising based on an image collection.

An action 202 comprises identifying an image collection made up of at least one image. As mentioned above, such an image collection may include images taken by users, images shared between users, and other sources of images in which the user has demonstrated some interest. If possible, the collection is selected based on some type of user grouping, to increase the chances that the images of the collection relate to a common theme or topic.

In various implementations content service 102 may be configured to select the collection of images from user images 106 at various levels of granularity. For example, content service 102 may be configured to select a single image as the collection of images, subsets of images in the user's account as the collection of images, and all of the images in the user's account as the collection of images. Similarly, content service 102 may be configured to select images the user has received from other users as the collection of images, images the user has sent to other users as the collection of images, and images from web pages the user has requested as the collection of images.

In many situations, the collection will be defined simply as the group of images that has been requested for current viewing by the user, on a single web page.

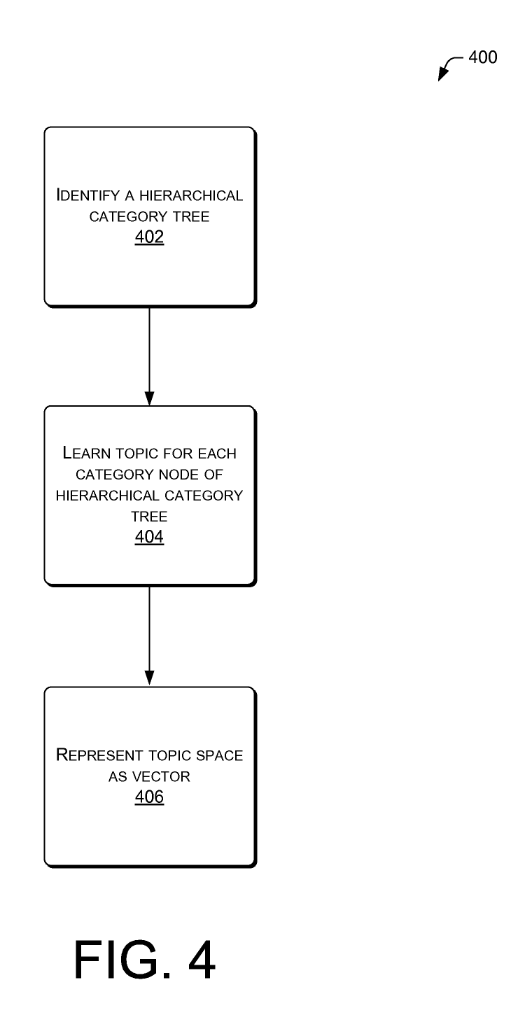

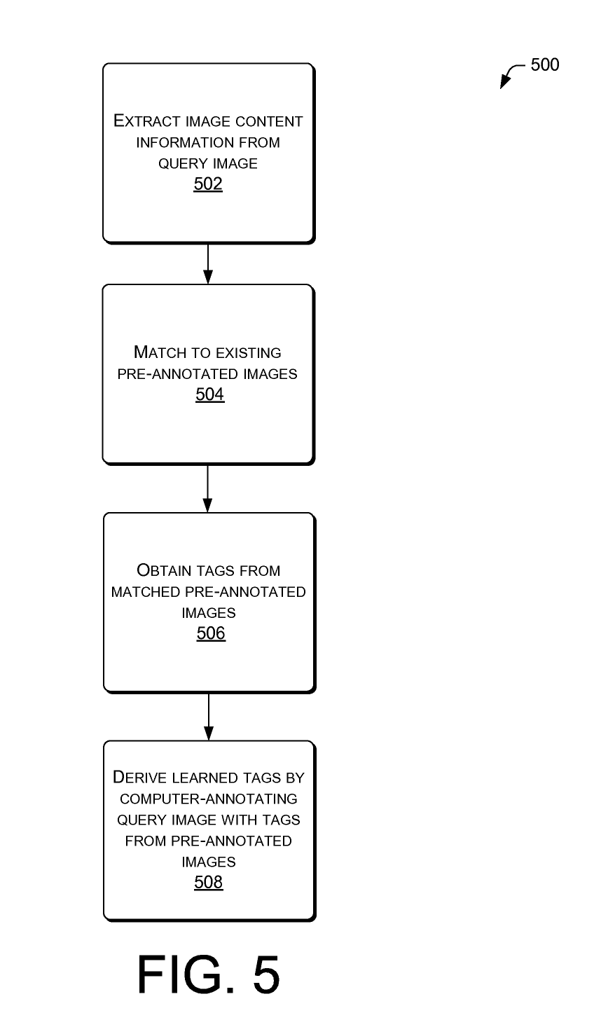

At 204, interest learning logic 108 learns a collection topic by analyzing the personal image collection identified at 202. Generally, this is accomplished by searching pre-annotated images 110 for graphically similar images, and using the tags of those images to determine a collection topic. More specifically, a search is performed for each image of user images 106, to find graphically similar images from pre-annotated images 110. The tags of the found images are then associated with the user image upon which the search was based. After this is completed for each image of the image collection, the newly associated tags of the image collection are analyzed to determine a collection topic. This will be explained in more detail with reference to FIGS. 4 and 5.

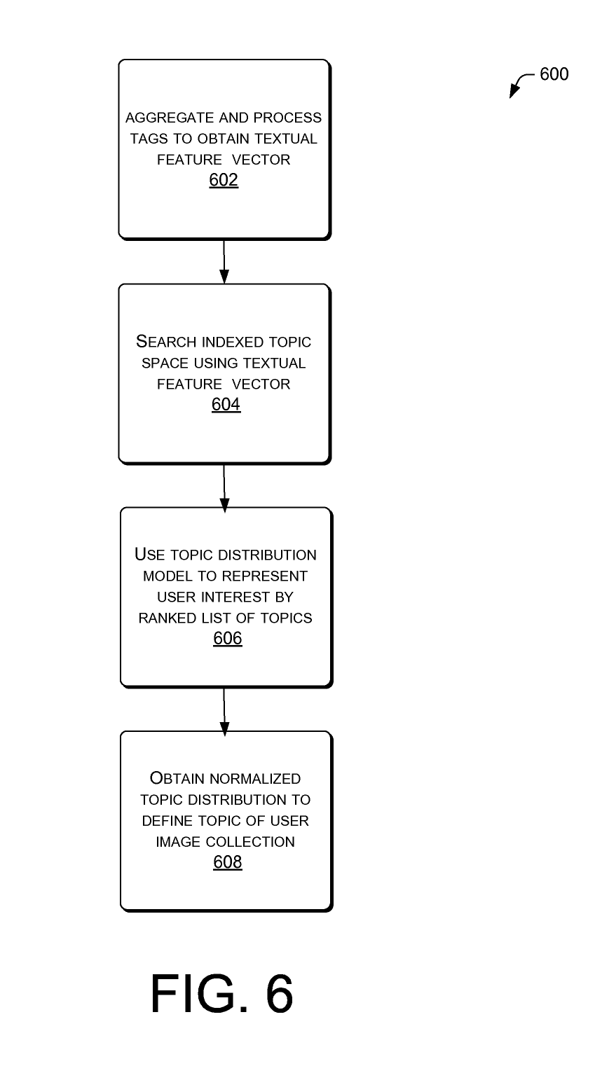

Action 206, performed by advertising selection logic 112, comprises selecting advertisements corresponding to the topic learned in 204. Additionally or alternately, advertisements may be solicited corresponding to the topic learned in 204. Action 206 is accomplished by comparing the learned user topic to the topics of available advertisements. This will be explained in more detail with reference to FIG. 6.

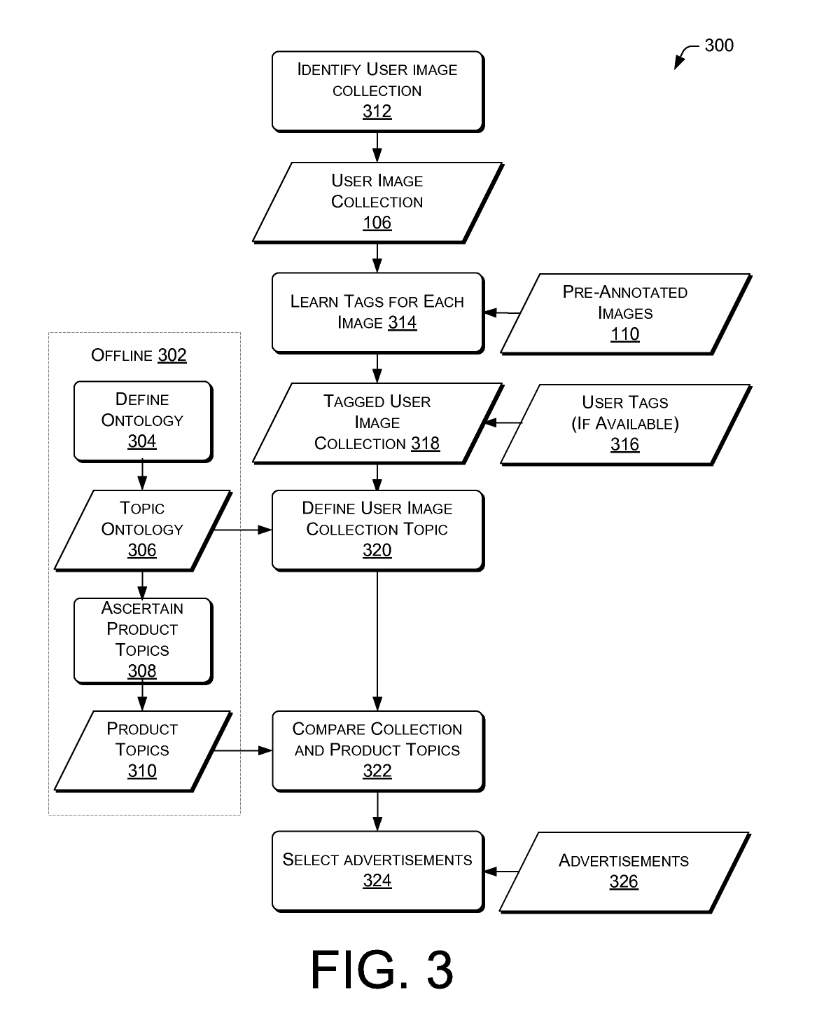

FIG. 3 shows another example 300 of how advertisements can be selected based on graphical content of image collections.

The process shown in dashed block 302 is an offline process, performed once, prior to the other actions shown in FIG. 3, to prepare reference data which will be used by the run-time process of dynamically selecting advertisements shown on the portion of FIG. 3 that is outside of block 302.

Action 304 comprises defining an ontology of topics 306. Topic ontology 306, also called a topic space, is defined with a hierarchical tree structure. The ontology comprises a hierarchical category tree, which is based on an open directory project (ODP) or concept hierarchy engine (CHE), or other available taxonomies. The hierarchical category tree is made up of category nodes. In the hierarchical structure, category nodes represent groupings of similar topics, which in turn can have corresponding sub-nodes or smaller groups of topics. Action 304 is discussed in more detail with reference to FIG. 4.

Action 308 comprises ascertaining advertising topics or product topics 310. The product topics may be ascertained based on the topic ontology 306.

Topic ontology 306 and product topics 310 are compiled offline, and used as resources in other steps of process 300, as further described below. In other embodiments, the product topics can be determined dynamically, in conjunction with learning topics for user image collections.

Actions 312 through 324, shown in the vertical center of FIG. 3, are typically performed in response to a request received at content service 102 for some type of content that includes images. In conjunction with the requested images, advertisements will be selected and provided to the requesting user or viewer.

An action 312 comprises identifying an image collection 106 as already discussed. Action 314 comprises learning tags corresponding to the individual images of image collection 106. Tags are learned for each image of the user image collection 106 based on a search of pre-annotated images 110 to find graphically similar images from pre-annotated images 110. Tags from the found images are then associated with the user image upon which the search was based. This results in a collection of tagged user images, shown as tagged user image collection 318. Tagged user image collection 318 has the same images as user image collection 106, except that each image now has one or more tags or other descriptive data. Note that the images of tagged user image collection 318 also retain any user tags 316 that were originally associated with the images.

In turn, at 320 the tags of the tagged user image collection 318 are used as the basis of a textual search against topic ontology 306 define a user image collection topic at 320. Action 322 comprises comparing or mapping the user image collection topic to advertising or product topics 310. Action 324 comprises selecting an advertisement from available advertisements 326 based on the comparison at 322.

### Topic Ontology

FIG. 4 shows an example of how a topic ontology is created at 400. This corresponds to offline step 304 of FIG. 3, although in alternate embodiments all or part of step 304, such as updating the topic space may be accomplished online. A topic ontology, also called a topic space, is a hierarchical ontology effective for representing users' interests. In this description, at 402 a hierarchical category tree is identified upon which to build the hierarchical topic space. In this example, the hierarchical topic space is built offline using a publicly available ontology provided by the Open Directory Project (ODP), a concept hierarchy engine, or other such hierarchical category tree.

ODP is a manually edited directory. Currently it contains 4.6 million URLs that have been categorized into 787,774 categories by 68,983 human editors. A desirable feature is that for each category node of ODP, there is a large amount of manually chosen web pages that are freely available to be used for either learning a topic or categorizing a document at the query time. Topic ontology 306 is based on the ODP tree, along with a topic that is learned for each ODP category node based on its associated web pages.

At 404, using the ODP tree, a topic is learned for each category node based on the web pages associated with the node. One way to learn these topics is to represent each web page attached to the corresponding category node by a vector space model, for example weighted by term frequency-inverse document frequency (TF-IDF, which will be discussed below). The weight vectors of all the web pages belonging in the category are then averaged. The resulting feature vector defines a topic.

This approach can work, but it has two disadvantages: 1) matching image tags with each leaf node of ODP is too time-consuming for an online application; 2) though the web pages that associate with a certain node may be about the same topic, not all sentences will be focused on this topic, e.g. there will be contextual sentences, or garbage sentences. For example, in an article describing the “sunflower” painted by Van Gogh, there may be sentences including information about the author of the article, and there may also be contextual sentences such as introduction to Van Gogh. Therefore a way to remove such noisy information and learn representative topics is required. An alternative approach can therefore be used. In this alternative approach, action 404 comprises block-wise topic identification followed by construction of an inverted index based on the ODP tree.

In the ODP tree, the web pages under the same node were chosen by human experts because they are about the same topic. It is reasonable to assume that there are two types of sentences among the web pages: topic-related sentences and topic-unrelated sentences. Typically, topic-related sentences will cover a small vocabulary with similar terms because they are similar to each other while topic-unrelated ones will have a much larger and more diverse term vocabulary in which the terms commonly appear in the web pages about other topics. Based on this assumption, a sentence or block importance measure is formulated to weight sentences according to their importance scores in interpreting the topic of the corresponding ODP category.

Block-wise topic identification supports real-time matching between queries and topics by differentiating salient terms, also called topic-specific terms, from noisy terms and/or stop words from the web pages associated with the nodes. In some embodiments, an inverted index based on one or more hierarchical category trees or ontologies is built to make topic matching efficient enough for real-time matching between topics in the topic space and queries. In at least one embodiment a combination of block-wise topic identification and an inverted index are used to learn an efficient topic space.

When a group of images, such as a web page, or photo stream are associated with a category node, such as a node in a concept hierarchy engine tree, an open directory project tree, or other such hierarchical category tree, the group of images may be represented in a vector space model. In at least one embodiment the vector space model is weighted using term frequency-inverse document frequency (TF-IDF), and the weight vectors of all or a plurality of the groups of images belonging to the category are averaged to obtain a feature vector that defines the topic. Similarly a text importance measure may be used in block-wise topic identification to weight a text group, phrase, and/or sentence from web pages according to importance scores for interpreting a topic of a corresponding hierarchical category tree.

Block bᵢ is similar to block bⱼ if their cosine similarity is larger than a predefined threshold ε, and block b is similar to web page d if at least one block selection of d is similar to b. B(b, d) denotes this relationship, and B(b, d)=1 when b is determined to be similar to d, and B(b, d)=0 when b is not determined to be similar to d. A frequency measure (F) for the i^{th} text group bᵢ when n represents the total number of web pages associated with the hierarchical category under consideration, and dⱼ is the j^{th} web page. The frequency measure (F) is defined by the following equation.

Fᵢ=Σⱼ₌₁ⁿB(bᵢ,dⱼ)

The frequency measure (F) measures to what extent a block is consistent with the topic-related web pages in the feature space. The larger the frequency, the more important the block is in representing the topic of the corresponding category.

Inverse web page frequency (IWF) is defined to quantify the occurrence of a block bᵢ that is also similar to web pages of other categories. Thus, that particular block is not as important, noisy with regard to the topic, or may not be related to the topic. Where N is a number of web pages randomly sampled from categories from a hierarchical tree, (IWF) is defined by the following equation.

$${IWF}_{i} = log \frac{N}{{\sum }_{j = 1}^{N} B ( {b}_{i} , {d}_{j} )}$$

Importance (M) of block bᵢ is defined based on the frequency measure (F) and inverse web page frequency (IWF) representing a normalized F-IWF score using the following equation.

$${M}_{i} = \frac{{F}_{i} \times {IWF}_{i}}{{\sum }_{j = 1}^{N} {F}_{j} \times {IWF}_{j}}$$

Depending upon the implementation the block may be a text group, sentence, paragraph, sliding window, etc. In each instance, a higher M score indicates the block is more important for a certain topic. For example, a block is important for a certain category if it has a localized distribution, or the block has many near-duplicates in a particular category while the block has few near-duplicates in other categories. This formulation expands on the TF-IDF weighting scheme used in text search and text mining The TF-IDF used in text search and text mining measures the importance of a term with respect to a document, to assign a high weight to a term if it has a high frequency in this document and while having a low frequency in the whole corpus. This formulation also expands on a region importance learning method applied in region-based image retrieval where a region is considered important if it is similar to many regions in other images deemed positive, while the region is considered less important if it is similar to many regions in both images deemed positive and images deemed negative.

Topic-related text groups are separated from topic-unrelated text groups based on the M score. Specific topics are learned from the topic-related text groups. In at least one embodiment, the specific topics are learned from the topic-related text groups using a particular block-wise topic identification method.

In this particular block-wise topic identification method, interest learning logic 108 separates the content of one or more web pages into blocks and each block is represented in a vector space model. For each category node, interest learning logic 108 clusters the blocks from web pages associated with the category node using a k-means algorithm. Thus, the cluster importance (CI) of the k^{th} cluster CIₖ defines the average block importance in the following equation, where B represents the number of blocks in the cluster.

$${CI}_{k} = \frac{1}{B} {\sum }_{i = 1}^{B} {M}_{i}$$

Topic-related blocks having a smaller vocabulary than topic-unrelated blocks means the topic-related blocks are more likely to be grouped into one cluster. Moreover, since topic-related blocks tend to have higher importance scores, the corresponding cluster is more likely to have a higher cluster importance score. Thus, clusters are ranked based on CI scores and in at least one implementation the top cluster is retained such that the blocks of the top cluster are identified as topic-related. A new vector space model is built based on the blocks from the top cluster, and the resulting weighted vector represents the corresponding topic. Iterating this process over the hierarchical category tree categories results in a hierarchical topic space.

At 406, the topic space may be represented in a vector space model in which a feature vector is created from the nodes of the hierarchical category tree. To enable online usage of the topic space, once a topic is represented as a weighted vector, the topic is treated as a document upon which an inverted index is built to index all of the topics, so that given a query term, all topics that contain this term can be instantly fetched. When a query has multiple terms, a ranked list of the intersection of the topics indexed by individual query terms is output. A hierarchical topic space that supports large-scale topic indexing and matching is thus obtained.

### Learning Product Topics

Product topics, referenced at blocks 308 and 310 of FIG. 3, are ascertained by using the text and keywords of available advertisements to learn a relevant advertising or product topic. When available, the product topic may be obtained from existing advertising tags. However, in the event that no advertising tags exist or to complement existing advertising tags, product topic learning may be performed by obtaining and mining the product description to determine a topic of the product. That is, the text and keywords of the available advertisements are used as search vectors against the topic ontology 306. As a result of this process, a list or database of available product topics is created, with one or more advertisements available corresponding to each topic of topic ontology 306. In alternate embodiments all or part of learning product topics, such as updating the topic space may be accomplished online.

### Learning Image Tags

FIG. 5 shows how step 314 of FIG. 3 is performed. Process 500 involves learning tags for each image of the user image collection. This transforms the user images collection from a collection of possibly un-tagged images to a collection of tagged or annotated images, in which each image has associated descriptive data 318.

Action 314 in the described embodiment comprises an automated analysis 500 which results in computer-annotation of each image from user image collection 106 with learned tags. Process 500 begins a content-based search by extracting image content information from a query image, also referred to as an image of interest, at 502. As typically referred to, “content-based search” or “content-based retrieval” signifies identification based on the image itself rather than keywords, tags, or metadata. Thus, in the context of this disclosure “image content” refer to objects, colors, shapes, textures, or any other information that can be derived from the image itself. Although in some instances such content may specifically refer to image content such as faces, objects, drawings, natural scenes, aerial images, images from space, medical images etc., while character may refer to image characteristics such as color, black-and-white, illumination, resolution, image size, etc., and feature may refer to image features such as pixilation, textures—Brodatz textures, texture mosaics, etc. image sequences—moving head, moving vehicle, flyover, etc.

At 502, image content information from the query image is extracted. In this context, extracting image content information includes deriving the image content information from an image when needed and/or accessing image content information that has previously been derived from an image. In some instances, extracting the image content information also includes storing the image content information. The extracted image content information may be analyzed based on one or more characteristics such as color, contrast, luminescence, pixilation, etc. without relying on existing keywords or image captions.

Although at least one image of interest may have an associated caption or tag, as discussed above, user-submitted tags may be unreliable. Interest learning logic 108 leverages a hierarchical topic space as discussed above, to obviate the problems of noisy tags and vocabulary impedance.

Additionally, when captions and tags are not necessary the user can be saved from this time consuming and tedious task. Thus extracted image content serves as a reliable source of objective values for automated comparison.

At 504, interest learning logic 108 compares the query image based on graphical similarity to images contained in an image corpus such as pre-annotated images 110. In some embodiments image similarity is determined using a data-driven approach. In this context, a data-driven approach refers to an objective and automated process that does not depend on human perception. For example, in at least one embodiment, hashed values represent image content of both the query image and images from pre-annotated images 110. The hash value of the image content from the query image is compared to the hash value of image content from the pre-annotated image database 110 to locate matches or reveal how the query image may relate to the database images.

Comparing the query image to images contained in the pre-annotated images may be represented by the following notations. A group of found keywords w* maximize a conditional distribution p(w|I_{q}), where I_{q} is the uncaptioned query image and w are terms or phrases in the vocabulary using the following equation.

w*=argmax_{w}p(w|I_{q})

Where Θ_{q} denotes the image search results, and p(w|Θ_{q}) investigates the correlation between Θ_{q} and w the following equation is obtained by application of the Bayesian rule.

w*=argmax_{w}p(w|Θ_{q})·p(Θ_{q}|I_{q})

Operating on the basis that there is a hidden layer of “image topics” so that an image is represented as a mixture of topics, and it is from these topics that terms are generated, a topic can be represented in the topic space by t in the following equation.

w*=argmax_{w}[maxₜp(w|t)·p(t|Θ_{q})]·p(Θ_{q}|I_{q})

As mentioned above, in some instances user images 106 may include user-submitted tags. These user-submitted tags may be included with the image as the query in the image retrieval step, and the image search results may be produced by first performing text-based image search based on the user-submitted tags, followed by graphically-based re-ranking to find both semantically and graphically relevant images. Thus, comparing the query image to images contained in the pre-annotated images incorporating user-submitted tags in the image query can be mathematically summarized by the following equation.

w*=argmax_{w}[maxₜp(w|t)·p(t|Θ_{q})]·p(Θ_{q}|I_{q},w_{q})

Image similarity between image(s) of interest and images from pre-annotated images 110 may also be determined at 504 using combinations of image content, and/or other graphical matching approaches. In each instance, determining image similarity at 504 does not rely on pre-existing tags or captions associated with the image(s) of interest.

At 506, interest learning logic 108 obtains tags from graphically similar images contained in pre-annotated images 110. The obtained tags may be mined from text associated with the matched image(s), text surrounding the matched image(s), captions, preexisting tags (p-tags), metadata, and/or any other types of descriptive data corresponding to the matched image(s) contained in pre-annotated images 110. Relevant terms are mined while noisy terms and stop words such as “a” and “the” are omitted from the mining result.

At 508, the image(s) of interest are computer-annotated based on one or more of the tags obtained in 506. By virtue of learning of the relationship between the query image and the images from pre-annotated images 110, the tags used in computer-annotation are called learned tags. Learned tags represent tags obtained by mining information from images determined to be similar from pre-annotated images 110. The process of learning tags for use in the computer-annotation, i.e., associating an image of interest with tags inferred to be relevant to the image(s) of interest, may also be called deriving learned tags and may be applied to a single image or a collection of images.

Computer-annotation results in learned tags comprising two types. The first type is called c-tags, referring to image content-based tags, which are computer-annotated tags corresponding to an image found graphically similar from an image corpus. The second type is called ck-tags, referring to image content-plus-keyword-based tags, which are computer-annotated tags corresponding to an image found graphically similar from an image corpus obtained using the image of interest and its user-generated or user-submitted tags (u-tags) as a query. On their own, user-submitted tags are referred to as u-tags, but as stated above, not all image(s) have u-tags, and it should be understood that existing tags or u-tags are not required.

When there is an exact match between a query image and an image from pre-annotated images 110, p-tags if available, may be used for computer-annotation of the image of interest. However, when no p-tags are available, a tag may be mined from a caption, description, or metadata of the image from pre-annotated images 110. As is usually the case however, when there is no exact match between an image of interest and an image from pre-annotated images 110, p-tags if available, may be used as input for computer-annotation of the image of interest, and when no p-tags are available, a tag may be mined from a caption, description, or metadata of the image from pre-annotated images 110. In each of the instances described in this paragraph, the learned tags may be represented as c-tags.

### Collection Topic Learning

FIG. 6 shows process 600 comprising using learned tags and any existing user tags as search terms or a vector for comparison against the topic ontology 306. The result is one or more topics that most closely match the learned and existing tags of the user image collection 106.

Action 320 comprises process 600 performed by interest learning logic 108 to define a user image collection topic using learned tags associated with the computer-annotated images of 316.

At 602, interest learning logic 108 aggregates the learned tags associated with an image of interest while stopwords are removed and stemming is performed. In this process some tags may be removed or edited. The remaining tags are weighted so that each image of the user image collection is represented by a textual feature vector. The textual feature vector represents a learned (also referred to as derived) image topic. As discussed in detail below, comparing textual feature vectors to a hierarchical ontology can be used to predict user interest based on a tagged user image collection such as 318.

At 604, interest learning logic 108 uses the textual feature vector obtained at 602 as a query to match the topic ontology 306. More specifically the textual feature vector representing the learned image topic is compared to a feature vector created from the nodes of the hierarchical category tree, and the intersection defines a user image collection topic as introduced at 320.

Comparing the tags of each image from the tagged user image collection 318 with the indexed topic space 306, and scoring the topics according to the corresponding cosine similarities between the topics and the query can be represented with the following notation. Interest learning logic 108 uses Iᵢ to represent an image, and θⱼ to represent the j-th topic such that T(Iᵢ) represents the feature vector with nonzero elements representing normalized similarity scores of retrieved topics where wⱼ(θⱼ) represents the normalized score of θⱼ. Thus, the feature vector represents the topic distribution of an image from the tagged user image collection 318.

T(Iᵢ)=[wⱼ(θⱼ)|Σⱼwⱼ(θⱼ)=1,0≦wⱼ(θⱼ)≦1]

At 606 a topic distribution model that leverages the topic ontology 306 is used such that user interest is represented by ranked list of topics. The topic distribution model allows a query image to be assigned to multiple topics so that interest is represented as a topic distribution. Alternately or in addition, a term distribution model may use a query feature vector to represent the interest in some embodiments.

The topic distribution model maps a query based on an image from the tagged user image collection 318 to the topic ontology 306 and represents the mined user interest by a ranked list of the topics that define the user image collection topics. The topic distribution model addresses noisy tags and vocabulary impedance by bridging both lexical and semantic gaps between the vocabulary of advertisements and the vocabulary of tagged images, particularly that of user-submitted tags.

Additional advantages of representing an image as a topic or concept distribution rather than categorizing an image to a certain concept include that the soft membership effectively handles textual ambiguities, e.g. “windows” can either represent a building product or an operating system and “apple” can either represent a fruit or a computer brand. In addition, representing an image as a concept distribution addresses semantic mismatch problems. For example, a photo of a soccer match may be labeled “soccer” and one of its suggested advertisements may be “FIFA champion watch” since both the photo and the advertisement have high weights on the concept “sports.”

In the described embodiment, the interest learning logic 108 iterates the process for each image in the tagged user image collection 318 and aggregates the topic distributions. At 608 topics with weights below a configurable threshold are removed to obtain the normalized topic distribution that is used to represent the interest mined from the query images. In this way, the mined interest facilitates targeted advertising based on the user image collection 106 without requiring the image(s) be tagged, and overcomes lexical and semantic gaps from user-submitted tags.

### Advertisement Ranking and Selection

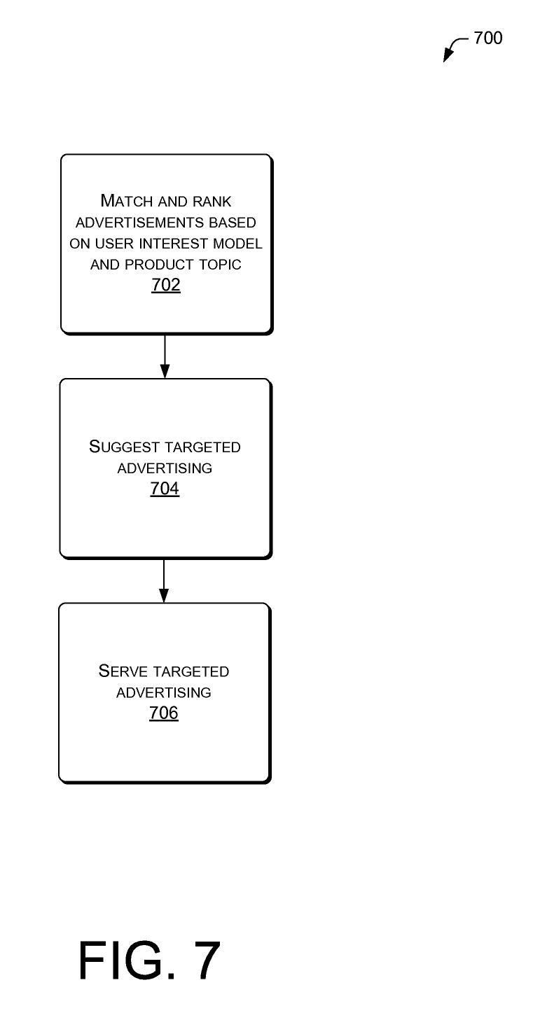

FIG. 7 shows further details of how advertisement selection logic 112 performs action 322 of comparing collection topics 320 and product topics 310. Action 322 in the described embodiment comprises an automated analysis 700 which compares collection topics 320 and product topics 310 to accomplish effective targeted advertising. By using the hierarchical category structure as described above, vocabulary impedance is overcome through defining a semantic topic space in which one or both of images and advertisements are represented as data points.

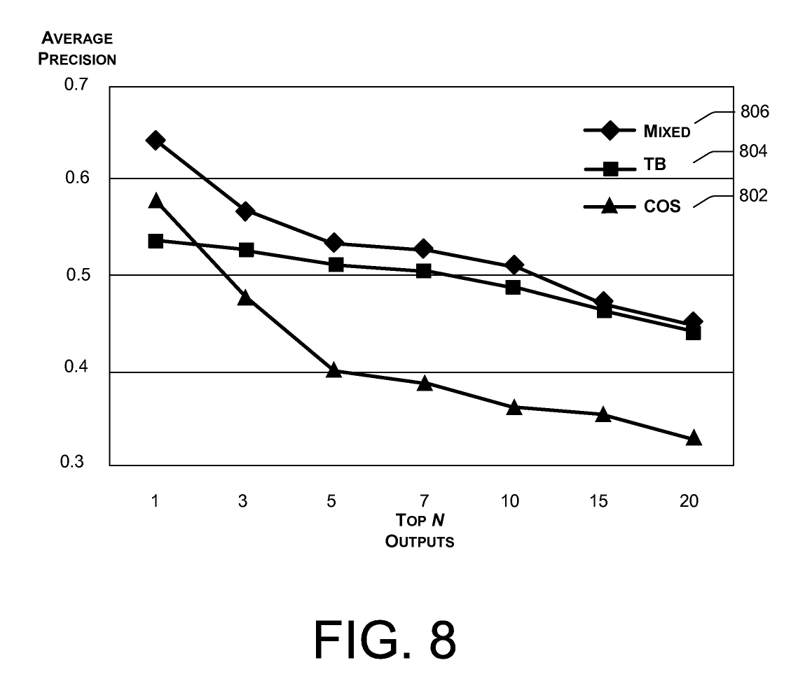

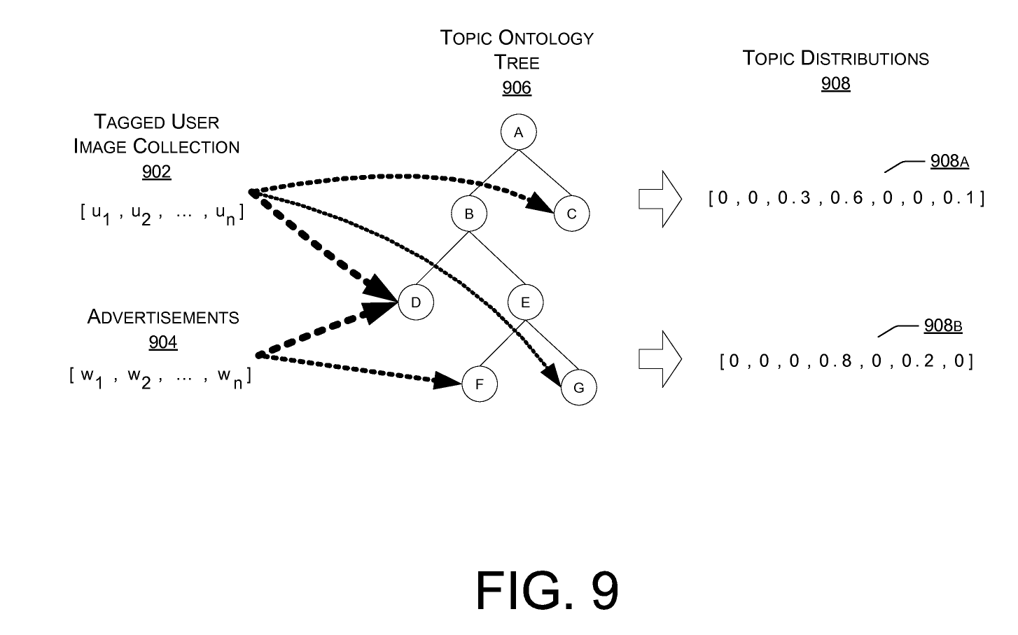

Action 702 represents advertising selection logic 112 performing advertisement matching and ranking based on a correspondence between the user interest collection topic and a product topic. Several models for advertisement matching and ranking represented at 602 are discussed in more detail below with regard to FIGS. 8 and 9. Targeted advertising is suggested at 704 based at least in part on the matching and ranking performed at 702. In at least one embodiment, at 704, the top L ranked products are suggested as relevant products for targeted advertising, where L is configurable and represents an integer from 1 to the number of matches obtained at 702. One or more of the suggested advertisements from 704 is provided at 706 in the illustrated operation. In at least one embodiment the number of advertisements to be provided and/or served is configurable.

FIG. 8 illustrates average precision of three models for identifying relevant advertisements. As represented by 802, a direct match model (COS) may be used to identify relevant advertisements. When the COS model is used, an advertisement is represented in the vector space model by topic ontology 306 and COS measures the cosine similarity between the term distributions of user images and advertisements. COS is used as a baseline method in the described embodiment.

A topic bridging model (TB), as represented by 804, may be used to identify relevant advertisements. When the TB model is used, an advertisement is mapped to the product topics 310 and represented with a product topic distribution. Then the advertisement is scored by its cosine similarity to a topic distribution from topic ontology 306 representing a user image collection. This dual mapping represents the use of an intermediate taxonomy. The advertisements are ranked in the descending order of their scores and the top ranked ones are returned for display at 706. The topic bridging model (TB) is discussed in more detail regarding FIG. 9, below.

In at least one embodiment, a mixed model, as represented by 806, is used to identify relevant advertisements. The mixed model performs a combination of the COS and TB models to avoid noise being introduced by the intermediate taxonomy of the TB model when textual descriptions of photos and advertisements represent a relevant match. In the mixed model, relevance of an advertisement adᵢ to a user interest query q where tb(·) and cos(·) represent the relevance scores output by TB and COS, respectively, and α is an empirically determined parameter which shows the confidence in tb(·). When α is set to zero, the model shifts to COS, and when α is set to one, the model shifts to TB. The mixed model is presented by the following equation.

Score_{mix(ad}_{ᵢ}_{,q)}=α*tb(adᵢ,q)+(1−α)*cos(adᵢ,q)

FIG. 9 illustrates an example of the topic bridging model (TB) as performed in at least one embodiment. A tagged user image collection 318 is represented by [u₁, u₂, . . . , uₙ,] at 902. Similarly, a group of possible advertisements are represented by [w₁, w₂, . . . , wₙ,] at 904. Both the images and the advertisements are matched with leaf topics of topic ontology tree 906 to obtain topic distributions 908. In the illustrated implementation, 908A represents the topic distribution corresponding to the tagged user image collection 902, and 908B represents the topic distribution corresponding to the advertisements 904. The dotted lines from the tagged user image collection 902 and the advertisements 904 to the leaf nodes of topic ontology tree 906 indicate matching with the topics represented by the leaf nodes, and the thicknesses of the dotted lines indicate a relative strength or value of the relevance score. Thus, in the illustrated example, both images 902 and advertisements 904 match the topic at leaf node D. Since the dotted lines from 902 and 904 to node D also are the heaviest, these are the strongest topic matches or have the highest relevance scores. Ranking of advertisements is then based on such representations.

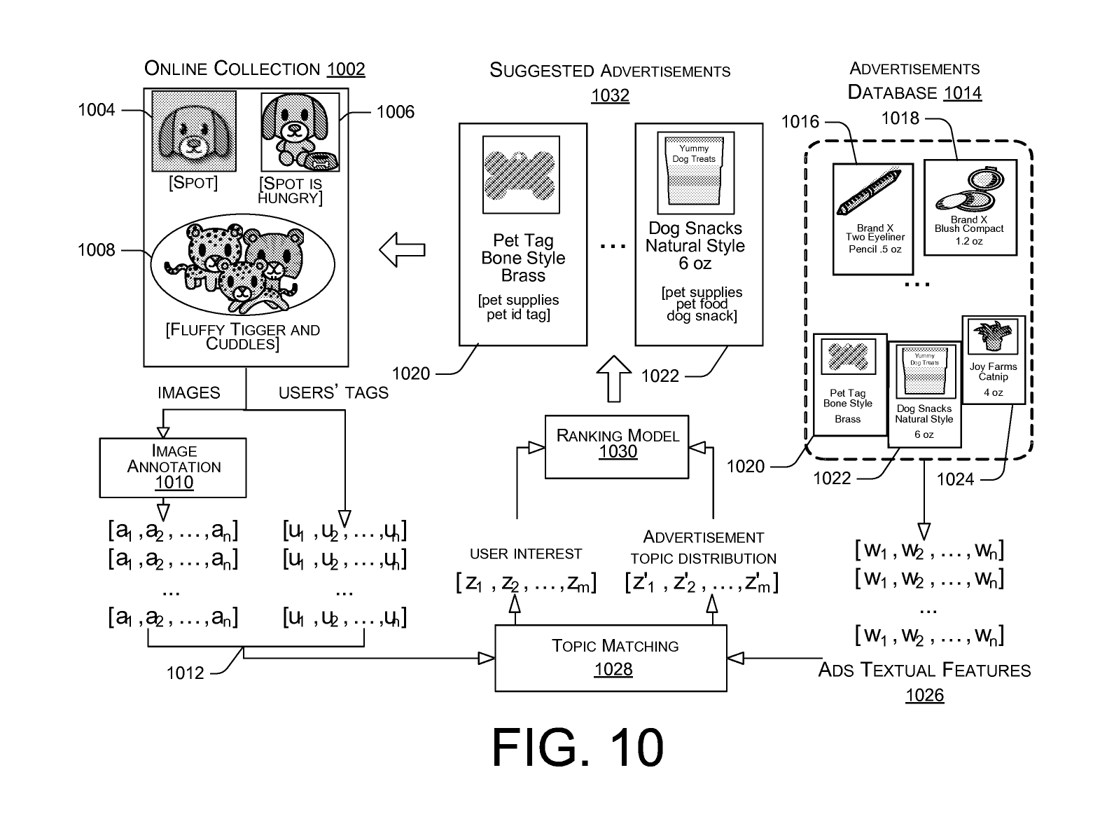

FIG. 10 is a data chart showing an illustrative implementation of interest learning from an image collection for advertising. In the example shown, user image collection 1002 includes three images, 1004, 1006, and 1008. One or more of the images in online collection 1002 may be photographs. In this example, each of 1004, 1006, and 1008 include corresponding user-submitted tags, [spot], [spot is hungry], and [fluffy tigger and cuddles] respectively. As discussed earlier, interest learning logic 108 performs automated analysis and computer-annotation at 1010 based on pre-annotated images 110 to learn tags a₁ to aₙ. The learned tags of 1010 may be aggregated with the user-submitted tags and further processed to learn a topic at 1012. In the sample shown, a variety of products with associated descriptions are available for advertising from an advertisements database 1014. Two make-up products are shown; at 1016 and 1018, while at 1020, 1022, and 1024 several pet related products are shown. At 1026 the textual features from the advertisements of advertisements database 1014 are obtained. Topic matching is shown at 1028. Image topic 1012 and the advertisement textual features 1026 are received at 1028, and topic matching at 1028 outputs a learned user interest and advertisements topic distribution based on the image topic 1012 and the advertisement textual features 1026. The outputs are used by a ranking model 1030 to provide suggested advertisements 1032. As shown, in this implementation the top two suggested advertisements based on the images from collection 1002 are the advertisements for a bone style pet tag 1020, natural style dog snacks 1022.

### Exemplary Operating Environment

The environment described below constitutes but one example and is not intended to limit application of the system described above to any one particular operating environment. Other environments may be used without departing from the spirit and scope of the claimed subject matter.

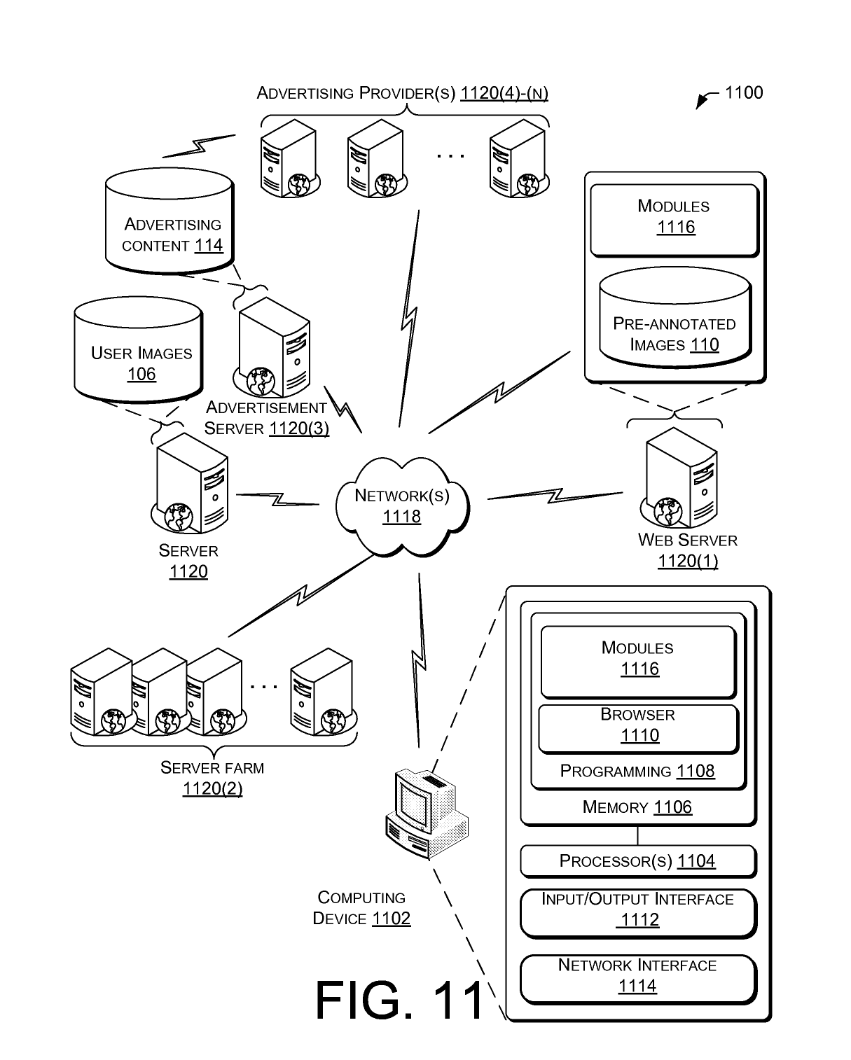

FIG. 11 illustrates one such operating environment generally at 1100 comprising at least a first computing device 1102 having one or more processor(s) 1104 and computer-readable media such as memory 1106. Computing device 1102 may be one of a variety of computing devices, such as a set-top box, cellular telephone, smart phone, personal digital assistant, netbook computer, laptop computer, desktop computer, or server. Each computing device having at least one processor capable of accessing and/or executing programming 1108 embodied on the computer-readable media. In at least one embodiment, the computer-readable media comprises or has access to a browser 1110, which is a module, program, or other entity capable of interacting with a network-enabled entity.

Device 1102 in this example includes at least one input/output interface 1112, and network interface 1114. Depending on the configuration and type of device 1102, the memory 1106 can be implemented as or may include volatile memory (such as RAM), nonvolatile memory, removable memory, and/or non-removable memory, implemented in any method or technology for storage of information, such as computer-readable instructions, data structures, program modules, or other data shown generally at 1116. Also, the processor(s) 1104 may include onboard memory in addition to or instead of the memory 1106. Some examples of storage media that may be included in memory 1006 and/or processor(s) 1104 include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the processor(s) 1104. The computing device 1102 may also include input/output devices including a keyboard, mouse, microphone, printer, monitor, and speakers (not shown).

Device 1102 represents computing hardware that can be used to implement functional aspects of the system shown in FIG. 1 at a single location or distributed over multiple locations. Network interface 1114 can connect device 1102 to a network 1118. The network 1118 may enable communication between a plurality of device(s) 1102 and can comprise a global or local wired or wireless network, such as the Internet, a local area network (LAN), or an intranet.

Device 1102 may serve in some instances as server 1120. In instances where device 1102 operates as a server, components of device 1102 may be implemented in whole or in part as a web server, in a server farm, as an advertisement server, and as one or more provider(s) of content. Although discussed separately below, it is to be understood that device 1102 may represent such servers and providers of content.

Device 1102 also stores or has access to user images 106. As discussed above, user images includes images collected by a user of device 1102, including photographs taken by consumers using digital cameras and/or video cameras and/or camera enabled cellular telephones, or images obtained from other media. Although shown located at server 1120 in FIG. 11, such content may alternatively (or additionally) be located at device 1102, sent over a network via streaming media or as part of a service such as content service 102, or stored as part of a webpage such as by a web server. Furthermore, in various embodiments user images 106 may be located at least in part on external storage devices such as local network devices, thumb-drives, flash-drives, CDs, DVRs, external hard drives, etc. as well as network accessible locations.

In the context of the present subject matter, programming 1108 includes modules 1116, supplying the functionality for implementing interest learning from images for advertising and other aspects of the environment of FIG. 1. In general, the modules 1116 can be implemented as computer-readable instructions, various data structures, and so forth via at least one processor 1104 to configure a device 1102 to execute instructions to implement content service 102 including interest learning logic 108 and/or advertising selection logic 112 based on images from user images 106. The computer-readable instructions may also configure device 1102 to perform operations implementing interest learning logic 108 comparing user images 106 with pre-annotated images 110 to derive a topic of interest, and matching the derived topic of interest with topics of advertising content 114 to target relevant advertising based on users' interests. Functionality to perform these operations may be included in multiple devices or a single device as represented by device 1102.

Various logical components that enable interest mining from one or more images including images from user images 106 may also connect to network 1118. Furthermore, user images 106 may be stored locally on a computing device such as 1102 or in one or more network accessible locations, streamed, or served from a server 1120.

In aspects of several embodiments server(s) 1120 may be implemented as web server 1120(1), in a server farm 1120(2), as an advertisement server 1120(3), and as advertising provider(s) 1120(N)-(Z). In various embodiments, advertisements may be served by or requested from advertising content 114 housed on an advertisement server 1120(3) or directly from advertising provider(s) 1120(4)-(N).

In the illustrated embodiment a web server 1120(1) also hosts pre-annotated images 116, alternately called an image corpus, which content service 102 searches for graphically similar images. As illustrated, modules 1116 may be located at a server, such as web server 1120 and/or may be included in modules 1116 on any other computing device 1102. Similarly, user images 106 may be located at computing device 1102, sent over a network such as network(s) 1118 via streaming media, stored at a server 1120, or as part of a webpage such as at web server 1120(1) or server farm 1120(2).

Aspects of computing devices, such as computing devices 1102 and 1120, in at least one embodiment include functionality for interest learning based on user images 106 using interest learning logic 108. For example, as shown from computing device 1102 and server 1120, program modules can be implemented as computer-readable instructions, various data structures, and so forth via at least one processing unit to configure a computer having memory to determine interests via operations of interest learning logic 108 comparing user images 106 with pre-annotated images 110 to derive a topic of interest, and advertising selection logic 112 matching the derived topic of interest with topics of advertising such as from advertising content 114 to target relevant advertising based on users' interests.

### Conclusion

Although the system and method has been described in language specific to structural features and/or methodological acts, it is to be understood that the system and method defined in the appended claims is not necessarily limited to the specific features or acts described. Rather, the specific features and acts are disclosed as exemplary forms of implementing the claims. For example, in at least one embodiment, process 200 as discussed regarding FIG. 2, is performed independently of processes 300, 400, 500, 600, and 700, as discussed regarding FIGS. 3, 4, 5, 6, and 7. However, in other embodiments, performance of one or more of the processes 200, 300, 400, 500, 600, and 700 may be incorporated in, or performed in conjunction with each other. For example, process 700 may be performed in lieu of block 206 of FIG. 2.

We claim:

1. A computer-readable medium having computer executable instructions encoded thereon, the computer executable instructions encoded for execution by a processor to configure the computer to perform interest mining operations comprising:
identifying a collection of one or more images associated with a user;
mining image content information of an image from the collection;
based at least on the image content information, determining an annotation corresponding to the image associated with the user, wherein determining the annotation corresponding to the image associated with the user is based at least in part on at least one of:
locating in an image repository using the image content information, an image that is graphically similar to the image associated with the user and mining descriptive data corresponding to the image that is graphically similar to the image associated with the user to derive a learned tag;
processing descriptive data corresponding to the image found in the image repository that is graphically similar to the image associated with the user to derive the learned tag;
annotating the image associated with the user with the learned tag;
based at least on the learned tag, deriving a topic of the image associated with the user;
obtaining a description of a product;
based at least on the description of the product, determining a topic of the product;
mapping the topic of the image associated with the user with the topic of the product;
repeating the mapping for a configurable number of products;
based at least on the mapping, calculating a ranking of topics of products in relation to the topic of the image associated with the user;
obtaining advertising for a configurable number of products based at least on the ranking;
providing a configurable number of advertisements from the obtained advertising.

2. A computer-readable medium as recited in claim 1, wherein the operations further comprise soliciting product advertising based at least on the derived topic of the collection of one or more images associated with the user.

3. A computer-readable medium as recited in claim 1, wherein the images associated with the user comprise informal images comprising one or more of:
photographs taken with a cellular telephone;
photographs taken with a digital camera;
photographs scanned by users;
photographs emailed by users;
photographs saved by users.

4. A method of selecting advertising comprising:
identifying a collection of one or more images;
determining a collection topic for the collection of one or more images;
determining a product topic corresponding to each of a plurality of product advertisements;
searching among the product topics to find one or more product topics similar to the collection topic;
selecting those product advertisements corresponding to the similar product topics.

5. A method as recited in claim 4, wherein determining a collection topic comprises:
for each image of the collection, searching for graphically similar images, the graphically similar images having associated descriptive data;
searching a topic space based on the associated descriptive data of the graphically similar images.

6. A method as recited in claim 4, wherein at least one of the collection of one or more images has associated descriptive data, and wherein determining a collection topic comprises:
for each image of the collection, searching for graphically similar images, the graphically similar images having associated descriptive data;
searching a topic space based on the associated descriptive data of the graphically similar images and on the descriptive data of the collection of one or more images.

7. A method as recited in claim 4, further comprising:
creating a hierarchical topic ontology;
wherein determining a collection topic comprises:
for each image of the collection, searching for graphically similar images, the graphically similar images having associated descriptive data;
searching the hierarchical topic space based on the associated descriptive data of the graphically similar images.

8. A method as recited in claim 4, wherein the collection of one or more images comprises a plurality of images to be displayed together on a web page.

9. A method as recited in claim 4, wherein the collection of one or more images comprises a plurality of images that have been grouped together by a user.

10. A method as recited in claim 4, wherein determining a product topic comprises:
searching a topic space based on textual data associated with the product advertisements.

11. A method of Internet advertising, comprising:
identifying a collection of one or more images associated with Internet browsing activities of a user;
searching an image library for images that are graphically similar to the collection of one or more images associated with the Internet browsing activities of the user, the graphically similar images having associated descriptive data;
processing the descriptive data of the graphically similar images to derive a topic for the collection of one or more images associated with the Internet browsing activities of the user;
selecting advertising based at least in part on the derived topic; and
presenting the selected advertising to the user in response to the browsing activities of the user.

12. A method as recited in claim 11, wherein processing the descriptive data comprises searching a product topic space based on the descriptive data.

13. A method as recited in claim 11, wherein identifying the collection of one or more images comprises identifying one or more images of a web page requested by the user.

14. A method as recited in claim 11, wherein identifying the collection of one or more images comprises identifying images that have been grouped together by the user.

15. A method as recited in claim 11, wherein searching the image library comprises:
deriving image content information from each of the one or more images associated with Internet browsing activities of a user;
comparing the derived image content information to image content information of images in the image library.

16. A method as recited in claim 11, wherein processing the descriptive data comprises:
removing stop words from the descriptive data of the graphically similar images;
mining the descriptive data of the graphically similar images for one or more terms;
applying the one or more terms to the one or more images associated with the Internet browsing activities of the user to derive the topic for the collection of one or more images associated with the Internet browsing activities of the user.

17. A method as recited in claim 11, wherein processing the descriptive data comprises:
removing stop words from the descriptive data of the graphically similar images;
mining the descriptive data of the graphically similar images for one or more terms;
applying the one or more terms to the one or more images associated with the Internet browsing activities of the user as learned tags;
deriving the topic for the collection of one or more images associated with the Internet browsing activities of the user from one or more of the learned tags.

18. A method as recited in claim 11, wherein selecting advertising comprises comparing the derived topic to advertising topics.

19. A method as recited in claim 11, further comprising serving the advertising based at least on a ranking of the advertising topics compared with the derived topic.

20. A method as recited in claim 11, wherein presenting the selected advertising comprises displaying the selected advertising on a web page along with the one or more images associated with the Internet browsing activities of the user.
